(19) United States
(12) Patent Application Publication
(10) Pub. No.: US 2008/0144640 A1
(43) Pub. Date: Jun. 19, 2008

(54) METHOD AND SYSTEM FOR MANAGING COMMUNICATION IN COMMUNICATION NETWORKS

(75) Inventor: Esperanza Alonso, Madrid (ES)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/612,556

(22) Filed: Dec. 19, 2006

(51) Int. Cl. H04L 12/56

(52) U.S. Cl. 370/401; 370/392

(57) ABSTRACT

A method and system for managing communication in a communication network is provided. A call server receives a call-request to establish a specific call with a terminating communication device. This call-request is received from an initiating communication device. The call server broadcasts an acknowledgement-request to a first set of controller devices to ascertain the presence of the terminating communication device in a first region. The first region is associated with the first set of controller devices, which first set of controller devices support a higher data transmission rate as compared to a second set of controller devices that are associated with a second region. Furthermore, the method includes directing the specific call to an electronic device when the terminating communication device is in the second region.

### FIELD OF THE INVENTION

The present invention relates in general to communication networks, and more specifically, to a method and system for managing communication in the communication networks.

### BACKGROUND OF THE INVENTION

A communication network is an interconnection of communication devices that can communicate via, for example, Base Transceiver Stations (BTSs), Radio Network Controllers (RNCs), and Mobile Switching Centers (MSCs). Examples of the communication network include, but are not limited to, a Global System for Mobile Communication (GSM) network, a Code Division Multiple Access (CDMA) network, and a Universal Mobile Telecommunications System (UMTS) network. The GSM, CDMA and UMTS networks are based on different technologies that have evolved over a period of time. For example, GSM network is based on a second generation (2G) technology and the UMTS network is based on a third generation (3G) technology. A 3G technology network, for example, the UMTS network, operates on a higher bandwidth than a 2G technology network, for example, the GSM network. Consequently, the 3G technology network can provide additional services as compared to those provided by the 2G technology network. Examples of the additional services can include, but are not limited to, video conferencing services, video transferring services, and video telephony services.

In the present day scenario, all these types of technologies co-exist, with advanced technologies such as the 3G technology being less widespread. Consequently, there is a probability that a user, who is a subscriber of the 3G technology network, can come across areas that only support 2G technology. In such cases, the user cannot avail himself or herself of the additional services provided by the 3G technology network. For example, the user cannot receive a video call, which can be received in the 3G technology network. Hence, the user can miss important calls (video calls) while traveling in an area that only supports 2G technology.

For example, in one of the existing techniques, a caller may be prompted to compose a multimedia message for a user when the user is in the area that only supports 2G technology. In this event, the user cannot receive a video call from the caller. The multimedia message is transmitted to a multimedia server, and is delivered to the user when the user enters an area that supports 3G technology.

In the existing technique, an MSC needs to broadcast requests to locate the user, send a request to the caller to compose the multimedia message for the user, and send the multimedia message to the user when the user enters the area that supports 3G technology. This results in loss of resources in sending and receiving messages/requests. Further, if the caller is reluctant to compose the multimedia message, the user may not be able to receive urgent information.

In light of the foregoing discussion, there is a need for a method which ensures that a subscriber of a higher bandwidth network, for example, the 3G technology network, does not miss any special information when the subscriber is present in a lower bandwidth network, for example, the 2G technology network. Further, the method should not result in unnecessary wastage of the network resources.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates a communication network where various embodiments of the present invention can be practiced;

FIG. 2 illustrates a block diagram of a call server in accordance with an embodiment of the present invention;

FIG. 3 shows a flowchart illustrating a method for managing communication in a communication network in accordance with an embodiment of the present invention; and

FIG. 4 shows a flowchart illustrating a method for managing communication in a communication network in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION OF THE INVENTION

Before describing in detail the particular method and system for controlling devices in a network in accordance with various embodiments of the present invention, it should be observed that the present invention resides primarily in combinations of method steps related to the method and system for controlling devices in a network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising,’ or any other variation thereof, are intended to cover a non-exclusive inclusion, such that a process, method, article or apparatus that comprises a list of elements does not include only those elements but can include other elements not expressly listed or inherent to such a process, method, article or apparatus. An element proceeded by ‘comprises a . . . ’, does not, without more constraints, preclude the existence of additional identical elements in the process, method, article or apparatus that comprises the element. The term ‘another,’ as used in this document, is defined as at least a second or more. The term ‘includes’, as used herein, is defined as comprising.

In one embodiment of the present invention, a method for managing communication in a communication network is provided. The communication network includes at least one call server that corresponds to at least one region. The method at the at least one call server includes receiving a call-request to establish a specific call with a terminating communication device. The call-request is received from an initiating communication device. Further, the method includes broadcasting an acknowledgement-request only to a first set of controller devices. The acknowledgement-request is broadcast to ascertain presence of the terminating communication device in a first region of the at least one region. The first region is associated with the first set of controller devices. The first set of controller devices can support a higher data transmission rate than a second set of controller devices. Further, the method includes directing the specific call to an electronic device when the terminating communication device is present in a second region of the at least one region. The second region is associated with the second set of controller devices.

In another embodiment of the present invention, a call server is provided. The call server includes a receiver configured to receive a call-request from an initiating communication device to establish a specific call with a terminating communication device. The call server also includes a transmitter. The transmitter is configured to broadcast an acknowledgement-request only to a first set of controller devices. The acknowledgement-request is broadcast to ascertain the presence of the terminating communication device in a first region, which is associated with the first set of controller devices. Further, the transmitter is also configured to transmit the specific call to an electronic device when the terminating communication device is present in a second region, which is associated with a second set of controller devices.

In yet another embodiment of the present invention, a method for managing communication in a communication network is provided. The communication network includes at least one call server corresponding to at least one region. The method at the at least one call server includes receiving a call-request from an initiating communication device to establish a specific call with a terminating communication device. Further, the method includes broadcasting an acknowledgement-request only to a first set of controller devices. The acknowledgement-request is broadcast to ascertain the presence of the terminating communication device in a third generation (3G) communication network, which is associated with the first set of controller devices. Further, the method includes directing the specific call to an electronic device when the terminating communication device is present in a second generation (2G) communication network, which is associated with a second set of controller devices.

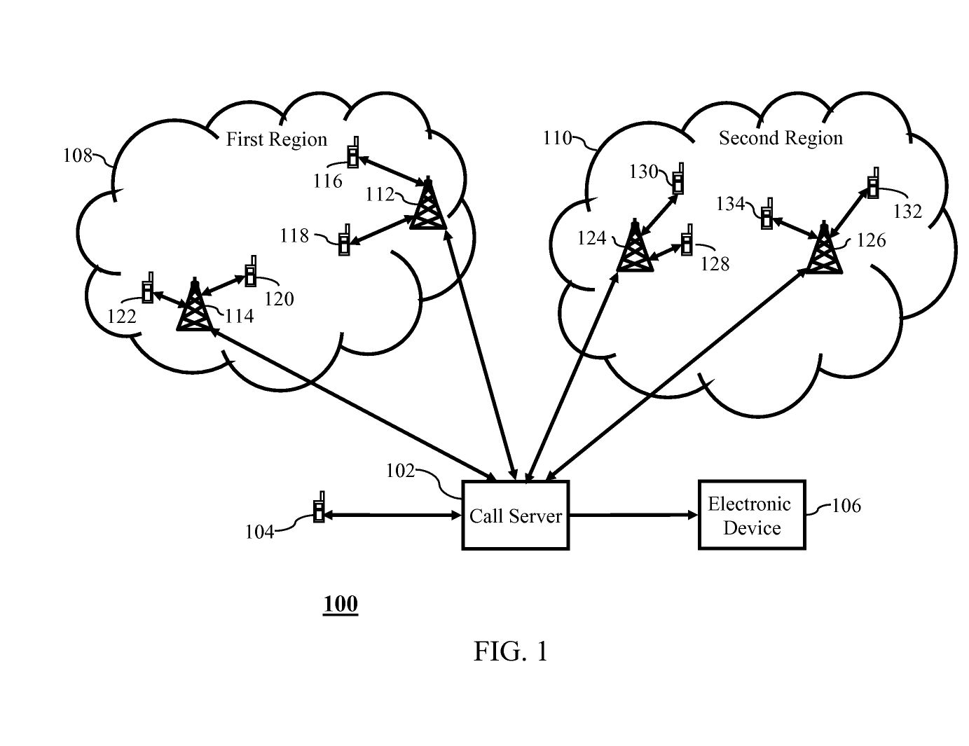

FIG. 1 illustrates a communication network 100 in accordance with an embodiment of the present invention. The communication network 100 is an interconnection of communication devices, spread over an area, which can communicate via controller devices, and at least one call server. Examples of the communication network 100 can include, but are not limited to, a Global System for Mobile Communication (GSM) network, a Code Division Multiple Access (CDMA) network, and a Universal Mobile Telecommunications System (UMTS) network. Further, the examples of the communication device include, but are not limited to, a mobile phone, a Personal Digital Assistant (PDA), and a satellite phone. The communication network 100 can be spread over at least one region, which can support the same or different technologies. Examples of such technologies include, but are not limited to, second generation (2G) wireless technology and third generation (3G) wireless technology. For some embodiments, the regions in the communication network 100 that support the 2G technology and the 3G technology can also be referred to as a 2G communication network and a 3G communication network, respectively. Examples of a 2G communication network can include, but are not limited to, a Global System for Mobile Communication (GSM) network, a Code Division multiple Access (CDMA) network, an Integrated Digital Enhanced Network (iDEN), an Interim Standard 95 (IS-95) network, and Digital Advance Mobile Phone Systems (D-AMPS) network. Examples of the 3G communication network include, but are not limited to, a Wideband Code Division Multiple Access (W-CDMA) network, a Generic Access Network (GAN), a Universal Mobile Telecommunications Systems (UMTS) network, a Code Division multiple Access 2000 (CDMA 2000) network, and a Time Division-Synchronous Code Division Multiple Access (TD-SCDMA) network.

For the purpose of this description, the communication network 100 is shown to include, among other elements, a call server 102, a communication device 104, an electronic device 106, a first region 108, and a second region 110. The call server 102 can facilitate communication in the communication network 100. An example of the call server 102 can be a Mobile Switching Center (MSC). Further, the communication device 104 can communicate with communication devices in the communication network 100 via the call server 102. In one embodiment of the present invention, the call server 102 can redirect a communication, for example, a call or a message, from the communication device 104 to the electronic device 106. The electronic device 106 can store calls, messages, and the like, which are redirected to the electronic device 106 by the call server 102. Examples of the electronic device 106 can include, but are not limited to, a mobile device that is configured as a Forward To Number (FTN) process, a video-mailbox server, a voicemail server, and a missed call-alert message server.

Further, the call server 102 facilitates communication in the first region 108 and the second region 110. The first region 108 can be associated with a first communication network that supports a higher bandwidth, for example, a 3G communication network. The first region 108 can support voice data and video-voice data. Examples of video-voice data can include, but are not limited to, video conferencing, video transferring, and video telephony.

Similarly, the second region 110 can be associated with a second communication network that supports a lower bandwidth than the first network. For example, the second network can be a 2G communication network.

FIG. 1 shows that the first region 108 and the second region 110 do not overlap with each other. However, it will be readily apparent to one with ordinary skill in the art, that the invention can also be practiced when the first region 108 and the second region 110 have an overlapping region. In this case, the overlapping region can support both the higher bandwidth and the lower bandwidth.

The first region 108 includes a first set of controller devices, for example, the controller devices 112 and 114. An example of the controller devices 112 and 114 can be a Radio Network Controller (RNC). The controller device 112 is shown to be associated with the communication devices 116 and 118. For example, when the call server 102 receives a call for the communication device 116, it routes the call through the controller device 112. Similarly, the controller device 114 is shown to be associated with communication devices 120 and 122.

The second region 110 includes a second set of controller devices, for example, the controller devices 124 and 126. An example of the controller devices 124 and 126 can be a Base Station Controllers (BSCs). The controller device 124 is shown to be associated with communication devices 128 and 130 and the controller device 126 with communication devices 132 and 134.

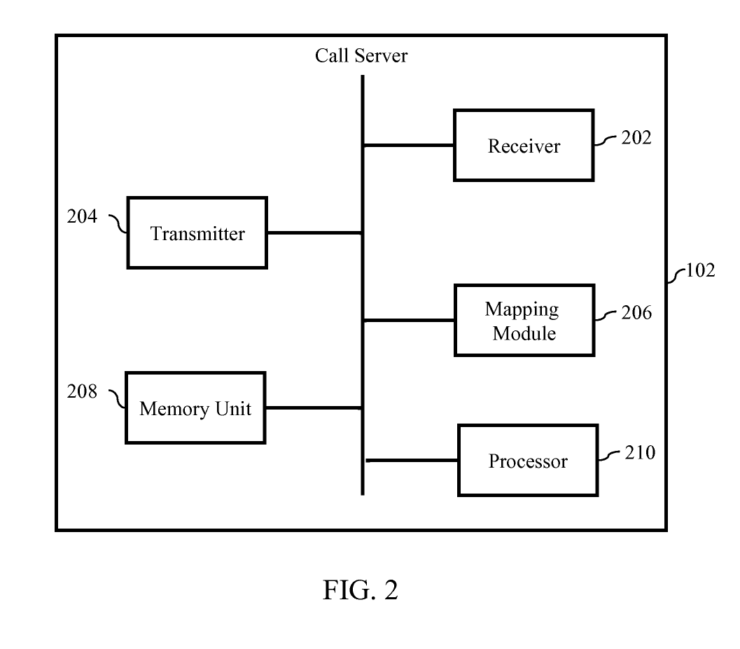

FIG. 2 illustrates a block diagram of a call server 102 in accordance with an embodiment of the present invention. Those ordinarily skilled in the art will appreciate that the call server 102 can include all or even a fewer number of components than the components shown in FIG. 2. Further, those ordinarily skilled in the art will understand that the call server 102 can include additional components that are not shown here, and are not germane to the operations of the call server 102. To describe the call server 102, reference will be made to FIG. 1, although it should be understood that the call server 102 can also be deployed in any other suitable environment or network.

The call server 102 includes a receiver 202 and a transmitter 204. The receiver 202 can receive a call-request from an initiating communication device, for example, the communication device 104. The call-request can be received to establish a specific call with a terminating communication device, for example, the communication device 116 or the communication device 128. Further, the specific call is such that it can be supported by a higher bandwidth network only. Consequently, only the first region 108 in the communication network 100 can support the specific call. Some examples of the specific call can include, but are not limited to, a video call, a multimedia call, and a video conference call. After the call-request is received at the receiver 202, the transmitter 204 can broadcast an acknowledgement-request to ascertain the presence of the terminating communication device in the first region 108. For this purpose, transmitter 204 broadcasts the acknowledgement-request only to the first set of controller devices, for example, the controller devices 112 and 114.

The call server 102 further includes a processor 210, such as such as one or more microprocessors, microcontrollers, digital signal processors (DSPs), combinations thereof or such other devices known to those having ordinary skill in the art. The particular operations/functions of processor 210, and thus of the call server 102, is determined by an execution of software instructions and routines that are stored in a memory unit 208 associated with the processor, such as random access memory (RAM), dynamic random access memory (DRAM), and/or read only memory (ROM) or equivalents thereof, that store data and programs that may be executed by processor 210. The memory unit 208 further stores information regarding the first set of controller devices, for example, the controller devices 112 and 114, and the second set of controller devices, for example, the controller devices 124 and 126.

The call server 102 can also include a mapping module 206. The mapping module 206 is configured to locate the first set of controller devices, for example, the controller devices 112 and 114. In various such embodiments, the transmitter 204 can retrieve the information regarding the first and the second set of controller devices from the memory unit 208 prior to broadcasting the acknowledgement-request. The transmitter 204 also can determine, by reference to mapping module 206, a location of the controller devices 112 and 114 prior to broadcasting the acknowledgement-request. Unless otherwise specified herein, the functionality described herein as being performed by the call server 102 preferably is implemented with or in software programs and instructions stored in the memory unit 208 and executed by the processor 210 of the of the call server.

In order to aid an understanding of the functioning of the call server 102, an exemplary embodiment of the present invention is illustrated below. In the exemplary embodiment, the receiver 202 receives a call-request from communication device 104 to establish a specific call with the communication device 116, which is associated with the controller device 112 of the first region 108. Further, the transmitter 204 broadcasts the acknowledgement-request to the controller devices 112 and 114. Thereafter, the controller device 112 sends an acknowledgement to the call server 102, which confirms the presence of the communication device 116 in an area covered by the controller device 112. In this embodiment, the receiver 202 can receive the acknowledgement sent by the controller device 112. Thereafter, the transmitter 204 routes the specific call to the terminating communication device.

When the terminating communication device is present in the second region 110, the receiver 202 may not receive any acknowledgement from either of controller devices 112 and 114. In such an instance, the transmitter 204 routes the specific call to the electronic device 106.

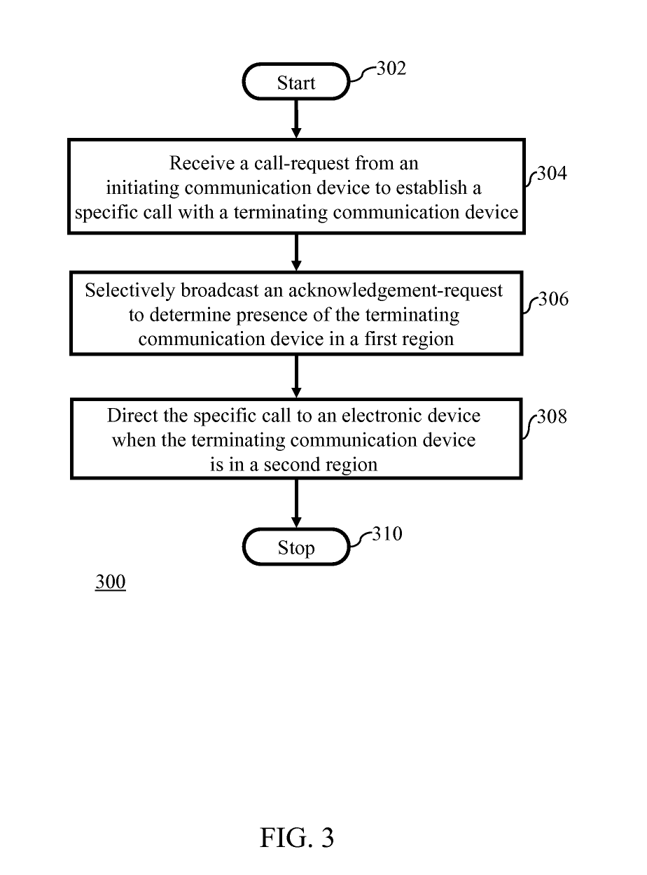

FIG. 3 is a flow diagram 300 illustrating a method for managing communication in a communication network in accordance with various embodiments of the present invention. To describe the flow diagram 300, reference will be made to FIG. 1 and FIG. 2, although it should be understood that the flow diagram 300 can also be implemented in any other suitable environment or network. Moreover, the invention is not limited to the order in which the steps are listed in the flow diagram 300. Further, the flow diagram 300 can contain a greater or fewer number of steps than shown in FIG. 3.

At step 302, the method for managing communication in communication network, for example, the communication network 100 is initiated at the call server 102. At step 304, a call-request is received by call server 102 from an initiating communication device, for example, the communication device 104, to establish a specific call with a terminating communication device, for example, the communication device 128. Examples of the specific call can include, but are not limited to a video call, a multimedia call, and a video and conference call. The call-request is received by the receiver 202. At step 306, the call server 102 broadcasts an acknowledgement-request to ascertain the presence of the terminating communication device, that is, the communication device 128, in the first region 108, which is a 3G communication network. The acknowledgement-request is broadcast by the call server 102, and more particularly by the transmitter 204, only to one or more controller devices associated with the first region 108, that is, the first set of controller devices, for example, the controller devices 112 and 114.

At step 308, the call server 102 directs the specific call to an electronic device, for example, the electronic device 106, when the terminating communication device, for example, the communication device 128, is in the second region 110 which is a 2G communication network. Examples of the electronic device include, but are not limited to, a Forward To Number (FTN), a video mailbox server, a voicemail sever, and a missed call-alert message server. The specific call is directed by the transmitter 204.

In an embodiment of the present invention, prior to broadcasting the acknowledgement-request, the call server 102 can determine whether the terminating communication device is already engaged in another call. In such an embodiment, the call server 102 can refer to a status of call-sessions which are being currently facilitated by the call server 102 to determine whether the terminating communication device is already engaged in another call. Further, by referring to the status, the call server 102 can also determine whether the terminating communication device is present in the first region 108 or the second region 110 while being engaged in the anther call. In the event that the terminating communication device is in the second region 110, the call server 102 can route the specific call to the electronic device 106. In the event that the terminating communication device is present in the first region 108, the call server 102 can send a call waiting message/alert to the terminating communication device. For example, the communication device 128 may be is engaged in another call when the call request is received. In such an instance, the call server 102 determines, by referring to the call-sessions status, that the target communication device 128 is engaged in another call, and can further determine that the target communication device 128 is present in the second region 110. Consequently, in this example, the call server 102 can route the specific call to the electronic device 106. Thereafter, the method terminates at step 310.

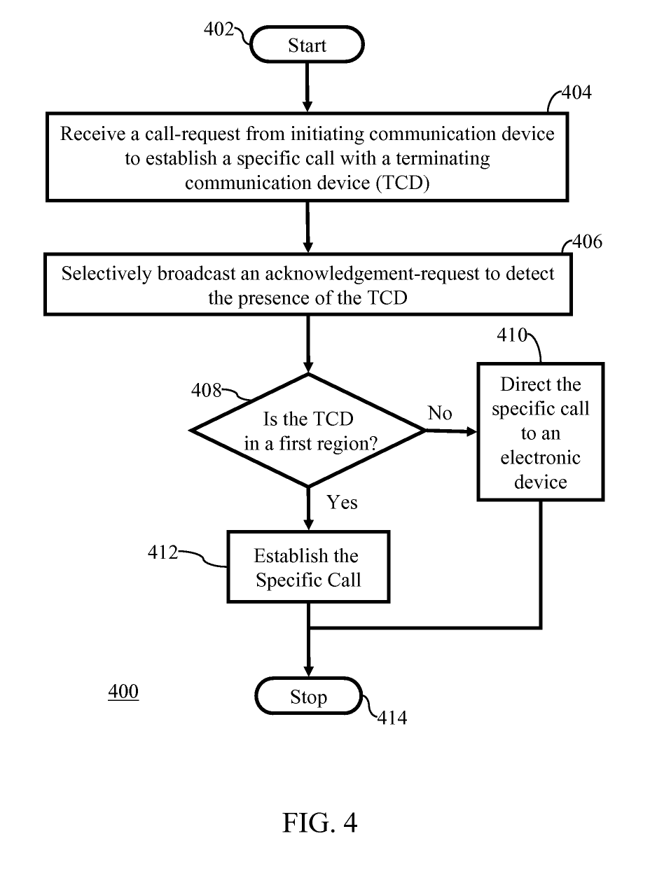

FIG. 4 is a flow diagram 400 illustrating a method for managing communication in a communication network in accordance with various embodiments of the present invention. To describe the flow diagram 400, reference will be made to FIG. 1 and FIG. 2, although it should be understood that the flow diagram 400 can be implemented in any other suitable environment or network. Moreover, the invention is not limited to the order in which the steps are listed in the flow diagram 400. Further, the flow diagram 400 can contain a greater or fewer numbers of steps than shown in FIG. 4.

At step 402, the method for managing a communication is initiated. At step 404, the call server 102 receives a call-request from an initiating communication device, for example, the communication device 104, to establish a specific call with a terminating communication device, for example, the communication device 116 or the communication device 128. Examples of the specific call can include, but are not limited to, a video call, a multimedia call, or a video and conference call. The call-request is received by the receiver 202.

At step 406, the call server 102 broadcasts an acknowledgement-request to ascertain the presence of the terminating communication device, for example, the communication device 116 or the communication device 128, in the first region, for example, the first region 108. For this purpose, the call server 102, and more particularly the transmitter 204, broadcasts the acknowledgement-request only to one or more controller devices associated with the first region 108, that is, the first set of controller devices, for example, the controller devices 112 and 114. Further, if the terminating communication device is present in the first region 108, a controller device of the first set of the controller devices will send an acknowledgement back to the call server 102, and more particularly to the receiver 202. For example, if the call-request is received for the communication device 116, then the controller device 112 sends an acknowledgement to the receiver 202. In such an instance, the receiver 202 receives the acknowledgement to confirm the presence of the terminating communication device 116 in the first region 108, which is a 3G communication network. However, if the call-request is received for the communication device 128, which is in the second region 110, the receiver 202 may not receive any acknowledgement, as the transmitter 204 did not send the acknowledgement-request to the controller devices 124 and 126 of the second region 110.

At step 408, the call server 102 determines whether the terminating communication device, for example, the communication device 116, is present in the first region 108. For example, the call server 102 may determine that the terminating communication device, for example, the communication device 116, is present in the first region 108 if the receiver 202 receives an acknowledgement from any one of the first set of controller devices 112 and 114. By way of another example, the call server 102 may determine that the terminating communication device, for example, the communication device 128, is not present in the first region if the receiver 202 does not receive an acknowledgement from the first set of controller devices 112 and 114.

If it is determined, at step 408, that the terminating communication device is not present in the first region 108, step 410 is performed. At step 410, the call server 102 directs the specific call to an electronic device, for example, the electronic device 106. Examples of the electronic devices can include, but are not limited to, a mobile device configured as Forward To Number (FTN), a video mailbox server, a voice mail server, and a missed call alert-message server.

If it is determined, at step 408, that the terminating communication device is present in the first region 108, which is a 3G communication network, step 412 is performed. At step 412, the call server 102 establishes the specific call between the initiating communication device and the terminating communication device. Thereafter, the method terminates at step 414.

In order to aid an understanding of the method for managing communication in the communication network 100, an exemplary embodiment is illustrated below. In the exemplary embodiment, the receiver 202 receives a call-request from the communication device 104 to establish a specific call with the communication device 116. Further, the transmitter 204 broadcasts an acknowledgement-request only to the controller devices 112 and 114. This acknowledgement-request is broadcast to determine the presence of the communication device 116 in the first region 108. Since the communication device 116 is associated with the controller device 112, the controller device 112 sends an acknowledgement to the receiver 202. Thereafter, the specific call is established.

In order to aid an understanding of the method for managing communication in the communication network 100, another exemplary embodiment is illustrated below. In the exemplary embodiment, the receiver 202 receives a call-request from the communication device 104 to establish a specific call with the communication device 128. Further, the transmitter 204 broadcasts an acknowledgement-request only to the controller devices 112 and 114. The acknowledgement-request is broadcast to ascertain the presence of the terminating communication device 128 in the first region 108. Since the communication device 128 is not associated with the controller devices 112 and 114, the acknowledgment is not received. Consequently, the specific call is directed to the electronic device 106.

Various embodiments of the present invention, as described above, offer several advantages, some of which are discussed here. Firstly, the present invention provides a method for preventing a subscriber of a high bandwidth network from missing a special communication, for example, a video call, which was sent to the subscriber when he/she was present in a lower bandwidth network. Since, the special communication, for example, the video call, does not fail even when the subscriber is in a lower bandwidth network, the subscriber can be billed for the special communication. Consequently, the Average Revenue Per User (ARPU) of operators of the lower and/or higher bandwidth network can be increased. Further, the present invention eliminates the requirement of excess resources to send messages/requests to the caller, the subscriber and the controller devices of the lower bandwidth network.

It will be appreciated that the method and system for managing communication in a communication network, described herein, may comprise one or more conventional processors and unique stored program instructions that control the one or more processors, to implement, in conjunction with certain non-processor circuits, some, most, or all of the functions of the system described herein. The non-processor circuits can include, but are not limited to, signal drivers, clock circuits, power-source circuits and user-input devices. As such, these functions may be interpreted as steps of a method to manage communication in a communication network. Alternatively, some or all the functions could be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one of with ordinary skill in the art would appreciate that various modifications and changes can be made, without departing from the scope of the present invention, as set forth in the claims below. Accordingly, the specification and figures are to be regarded in an illustrative rather than a restrictive sense, and all such modifications are intended to be include within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the dependency of this application, and all equivalents of those claims, as issued.

What is claimed is:

1. A method for managing communication in a communication network, the communication network comprising at least one call server corresponding to a plurality of regions, the method at the at least one call server comprising:
receiving a call-request to establish a specific call with a terminating communication device, wherein the call-request is received from an initiating communication device;
broadcasting an acknowledgement-request only to a first set of controller devices, wherein the acknowledgement-request is broadcast to ascertain a presence of the terminating communication device in a first region of the plurality of regions, wherein the first region is associated with the first set of controller devices, wherein the first set of controller devices are capable of supporting a higher data transmission rate than a second set of controller devices; and
directing the specific call to an electronic device when the terminating communication device is present in a second region of the plurality of regions, wherein the second region is associated with the second set of controller devices.

2. The method as recited in claim 1 further comprising:
receiving an acknowledgment from a controller device of the first set of controller devices when the terminating communication device is in the first region; and
establishing the specific call between the initiating communication device and terminating communication device when the acknowledgment is received.

3. The method as recited in claim 1, wherein the specific call is selected from the group comprising a video call, a multimedia call, and a video conference call.

4. A call server comprising:
a receiver configured to receive a call-request from an initiating communication device to establish a specific call with a terminating communication device; and
a transmitter configured to:
broadcast an acknowledgement-request only to a first set of controller devices, wherein the acknowledgement-request is broadcasted to ascertain the presence of the terminating communication device in a first region associated with the first set of controller devices, and
transmit the specific call to an electronic device when the terminating communication device is present in a second region associated with a second set of controller devices.

5. The call server as recited in claim 4, wherein the receiver is further configured to receive an acknowledgement from a controller device of the first set of controller devices when the terminating communication device is present in the first region.

6. The call server as recited in claim 4 further comprising a mapping module to locate the first set of controller devices.

7. The call server as recited in claim 4 further comprising a memory unit configured to store information of the first set of controller devices and the second set of controller devices.

8. The call server as recited in claim 4, wherein the electronic device is selected from the group comprising a mobile device configured as Forward To Number, a video mailbox server, a voice mail server, and a missed call alert-message server.

9. The call server as recited in claim 4, wherein the first set of controller devices are Radio Network Controllers.

10. The call server as recited in claim 4, wherein the first region is associated with a third generation wireless communication network.

11. The call server as recited in claim 4, wherein the second set of controller devices are Base Station Controllers.

12. The call server as recited in claim 4, wherein the second region is associated with a second generation wireless communication network.

13. The call server as recited in claim 4, wherein the call server is a Mobile Switching Center.

14. A method for managing communication in a communication network, the communication network comprising at least one call server corresponding to at least one region, the method at the at least one call server comprising:
receiving a call-request to establish a specific call with a terminating communication device, wherein the call-request is received from an initiating communication device;
broadcasting an acknowledgement-request only to a first set of controller devices, wherein the acknowledgement-request is broadcast to ascertain the presence of the terminating communication device in a third generation wireless communication network associated with the first set of controller devices;
directing the specific call to an electronic device when the terminating communication device is present in a second generation wireless communication network associated with a second set of controller devices.

15. The method as recited in claim 14 further comprising:
receiving an acknowledgment from a controller device of the first set of controller device when the terminating communication device is in the third generation communication network; and
establishing the specific call between the initiating communication device and the terminating communication device when the acknowledgment is received.

16. The method as recited in claim 14, wherein the first set of controller devices are Radio Network Controllers.

17. The method as recited in claim 14, wherein the second set of controller devices are Base Station Controllers.

18. The method as recited in claim 14, wherein the specific call is selected from the group comprising a video call, a multimedia call, and a video conference call.
